(19) United States
(12) Patent Application Publication
(10) Pub. No.: US 2003/0229562 A1
(43) Pub. Date: Dec. 11, 2003

(54) Automated auction system

(76) Inventors: Michael Marek, Stamford, CT (US); Troy Mills, Sandy Hook, CT (US); Rosana Rivera, Stamford, CT (US)

Correspondence Address: BUCKLEY, MASCHOFF, TALWALKAR, & ALLISON, 5 ELM STREET, NEW CANAAN, CT, 06840, US

(21) Appl. No.: 10/164,726

(22) Filed: Jun. 7, 2002

(51) Int. Cl. G06F 17/60

(52) U.S. Cl. 705/37

(57) ABSTRACT

A system for auctioning an item includes reception of an indication that the item has been repossessed, transmission of a request for an appraisal of a value of the item, reception of an appraised value of the item, automatic transmission of the appraised value to a lessee of the item in response to reception of the appraised value, automatic generation of a request to cancel a registration of the item in response to reception of the appraised value, determination of parameters of an auction for the item, conduction of the auction of the item based on the determined parameters, and automatic transmission of a notification to a possessor of the item identifying an auction winner and indicating that the auction winner has permission to obtain the item, of instructions for obtaining the item to the auction winner, and of an invoice for the item to the auction winner of a notification to the lessee indicating an amount to be credited to an account of the lessee in response to completion of the auction.

### BACKGROUND

1. Field

The present invention relates to systems for conducting auctions. More specifically, the present invention concerns, in some aspects, systems for managing auctions and for generating documents relating thereto.

2. Discussion

Sellers use conventional pricing systems when selling many copies of a particular item through retail channels. For example, a retailer may assign a price of fifty dollars to each of one hundred pairs of a particular shoe model sold by the retailer. Notably, the retailer is aware that some buyers may be willing to pay more than fifty dollars for a pair of the shoes. However, assigning a higher price may discourage other buyers from buying a pair. The assigned price is therefore intended to maximize an amount of revenue generated by the sale of the one hundred pairs.

Auctions are used in cases where a retailer seeks to maximize a sale price of a single item. Many types of auctions exist, most having the primary goal of maximizing the sale price of a particular item. Auctions are less prevalent than conventional retail pricing because of the greater administrative costs required by auctions.

Electronic auctions have sought to reduce the administrative costs associated with auctions. One popular electronic auction system is provided by eBay™. eBay allows a seller to post an item to its website, to define auction parameters for the item, and to receive bids from disparate bidders. eBay also provides procedures for delivery of the item to a winning bidder, delivery of funds from the winning bidder to the seller, and for warranting or otherwise guaranteeing buyer satisfaction. However, eBay does not provide for transfer of title, re-registration or other procedures that are associated with the sale of some types of item, such as cars, boats, or the like. Accordingly, conventional electronic auction systems are not suitable for auctioning such items.

Auctions for the above-mentioned items are known, however such auctions do not present the efficiencies and reduced costs of electronic auctions. Therefore, what is needed is a system for managing an auction that provides for efficient execution of procedures and/or generation of documents that are associated with the sale of some types of items.

### BRIEF DESCRIPTION

In order to address the foregoing, embodiments of the present invention concern a system, a method, an apparatus, a computer-readable medium storing processor-executable process steps, and means to auction registered items including reception of an appraised value of an item, to automatically generate a request to cancel registration of the item in response to reception of the appraised value, and to conduct an auction of the item. In other aspects, the present invention provides an interface for controlling an auction including an input area for inputting an appraised value of an item, wherein in response to input of the appraised value into the input area, a request to cancel registration of the item is automatically generated.

In still other aspects, the present invention relates to a system for auctioning an item in which an indication that the item has been repossessed is received, a request for an appraisal of a value of the item is transmitted, and an appraised value of the item is received. In response to reception of the appraised value, the appraised value is automatically transmitted to a lessee of the item, and a request to cancel registration of the item is automatically generated. Also according to this aspect, parameters of an auction for the item are determined, the auction of the item is conducted based on the determined parameters, and, in response to completion of the auction, a notification is automatically transmitted to a possessor of the item identifying an auction winner and indicating that the auction winner has permission to obtain the item, instructions for obtaining the item are automatically transmitted to the auction winner, an invoice for the item is automatically transmitted to the auction winner, and a notification is automatically transmitted to the lessee indicating an amount to be credited to an account of the lessee.

A technical content of some embodiments of the invention is the integration of document generation with electronic auction systems for use in the auctioning of particular types of items. With this and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a topographic view of a network architecture according to some embodiments of the present invention.

FIG. 2 is a block diagram of an internal architecture of an auction server according to some embodiments to the present invention.

FIG. 3 is a block diagram of an internal architecture of a dealer device according to some embodiments to the present invention.

FIG. 4 is a representative view of a tabular portion of a lessee database according to some embodiments of the present invention.

FIG. 5 is a representative view of a tabular portion of an address database according to some embodiments of the present invention.

FIG. 6 is a representative view of a tabular portion of an object database according to some embodiments of the present invention.

FIG. 7 is a representative view of a tabular portion of a status database according to some embodiments of the present invention.

FIG. 8 is a representative view of a tabular portion of an auction definition database according to some embodiments of the present invention.

FIG. 9 is a representative view of a tabular portion of an auction history database according to some embodiments of the present invention.

FIG. 10 is a representative view of a tabular portion of a sold database according to some embodiments of the present invention.

FIG. 11 is a representative view of a tabular portion of a document database according to some embodiments of the present invention.

FIG. 12 is a state diagram of systems according to some embodiments of the present invention.

FIG. 13 is a representative view of an interface according to some embodiments of the present invention.

FIG. 14 is a representative view of an interface according to some embodiments of the present invention.

FIG. 15 is a representative view of an interface according to some embodiments of the present invention.

FIG. 16 is a representative view of an interface according to some embodiments of the present invention.

FIG. 17 is a representative view of an interface according to some embodiments of the present invention.

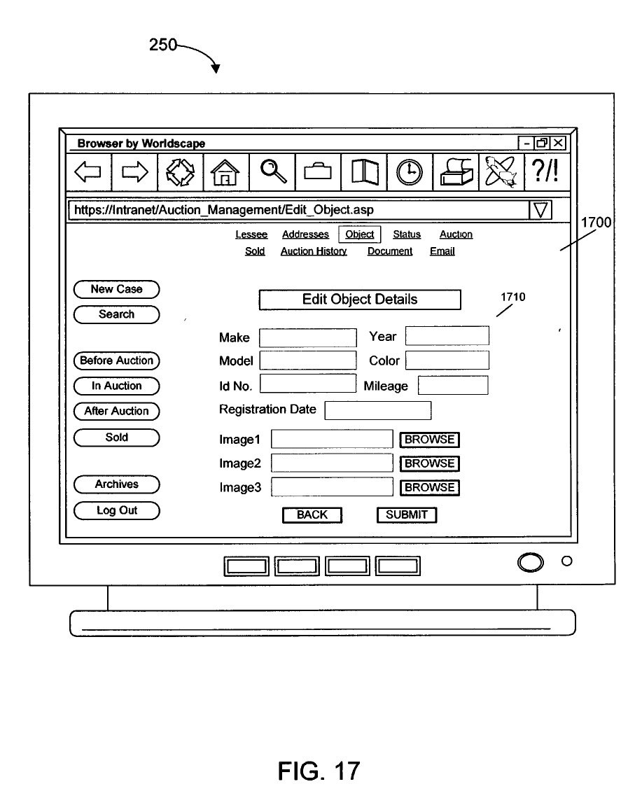

FIG. 18 is a representative view of an interface according to some embodiments of the present invention.

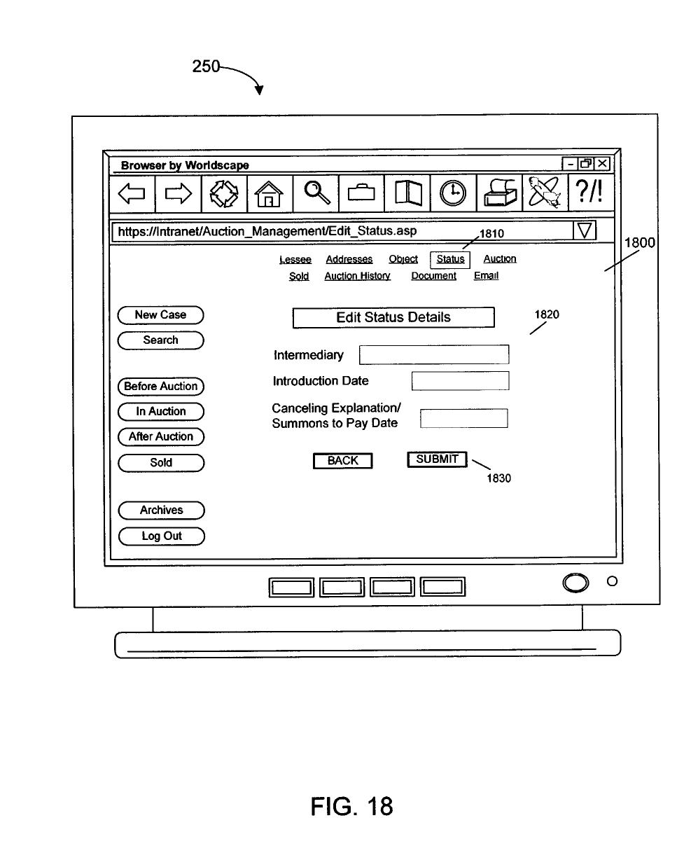

FIG. 19 is a representative view of an interface according to some embodiments of the present invention.

FIG. 20 is a representative view of an interface according to some embodiments of the present invention.

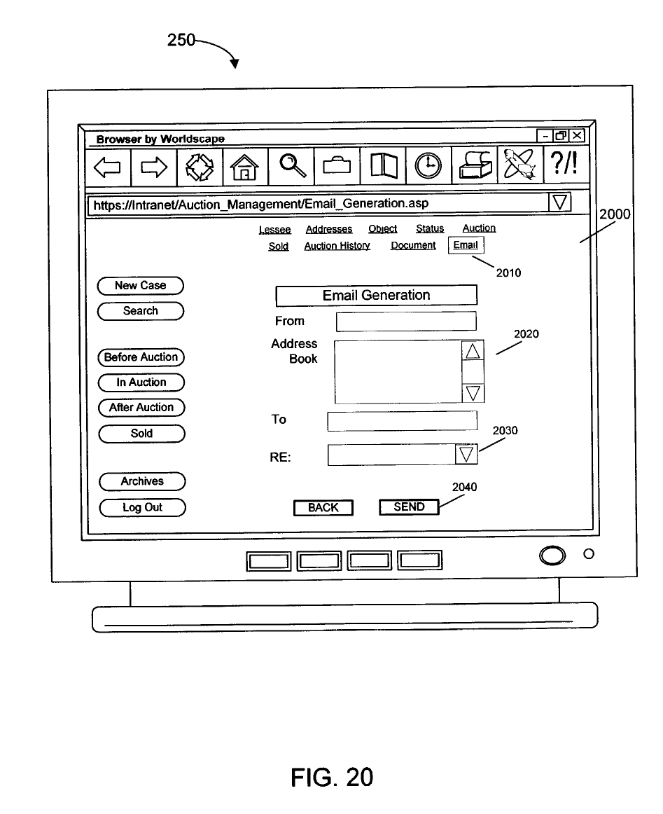

FIG. 21 is a representative view of an interface according to some embodiments of the present invention.

FIG. 22 is a representative view of an interface according to some embodiments of the present invention.

FIG. 23 is a representative view of an interface according to some embodiments of the present invention.

FIG. 24 is a representative view of an interface according to some embodiments of the present invention.

### DETAILED DESCRIPTION

System Architecture

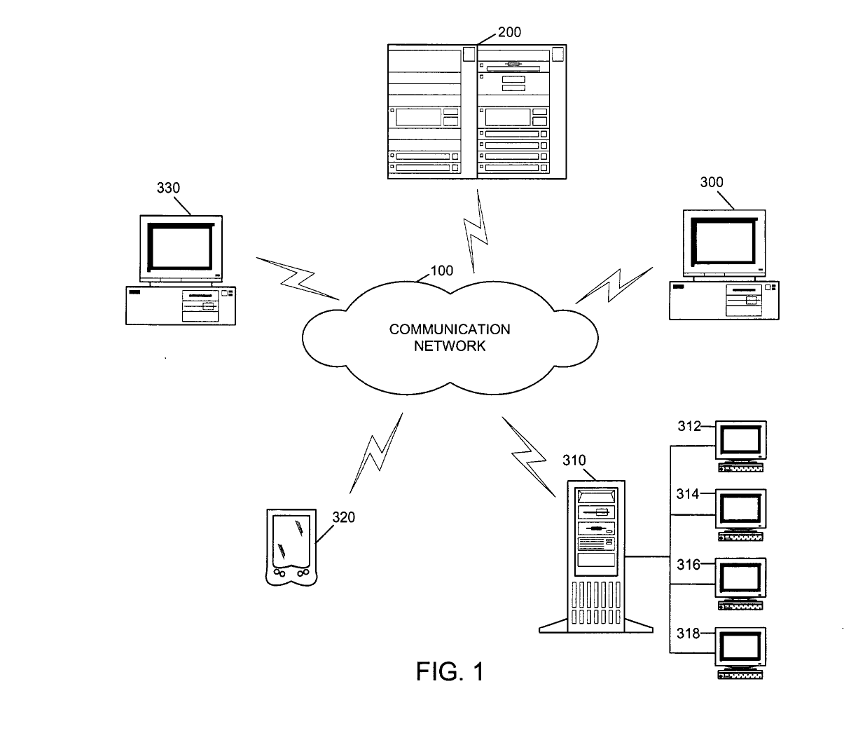

FIG. 1 illustrates a network architecture of a system according to some embodiments of the present invention. As shown, communication network 100 provides communication between auction server 200 and user devices 300 through 330.

Communication network 100 may comprise any number of different systems for transferring data, including a Local Area Network (LAN), a Metropolitan Area Network (MAN), a Wide Area Network (WAN), a proprietary network, a Public Switched Telephone Network (PSTN), a Wireless Application Protocol (WAP) network, a wireless LAN (e.g., in accordance with the Institute of Electrical and Electronics Engineers 802.11b standard), a Bluetooth network, an Infrared Radiation (IR) network, and/or an IP network such as the Internet, an intranet or an extranet. As used herein, the term “communication” can refer to wired and/or wireless communication as appropriate.

Auction server 200 may be operated by a lending institution or other type of entity. In some embodiments, auction server 200 provides its operator with the ability to control auctions. As will be described in detail below, this ability may include the ability to receive an appraised value of an item, to automatically generate a request to cancel registration of the item in response to reception of the appraised value, and to conduct an auction of the item.

In one specific example, a lessee defaults on a car lease owned by an entity operating auction server 200, and auction server 200 therefore issues an instruction to an intermediary repossession service to repossess the car. Next, auction server 200 receives an indication that the vehicle has been repossessed by the repossession service. Auction server 200 then transmits a request for an appraisal of the item's value to an appraisal service. After receiving the appraised value, the appraised value is automatically transmitted to the lessee, and the item's motor vehicle registration is cancelled. An operator uses an interface provided by auction server 200 to define parameters of an auction, and to conduct the auction based on the defined parameters. After the auction is conducted, a notification is automatically transmitted to a possessor of the item identifying an auction winner and indicating that the auction winner has permission to obtain the item, instructions for obtaining the item are automatically transmitted to the auction winner, an invoice for the item is automatically transmitted to the auction winner, and a notification is automatically transmitted to an owner of the item indicating an amount to be credited to an account of the owner. This and other specific examples are discussed in more detail below.

Auction server 200 is depicted as a mainframe server in FIG. 1, but may comprise any device or devices capable of performing process steps attributed to server 200 herein. Moreover, auction server 200 may provide auction services to more than one entities. Other services may also be provided by auction server 200, including functions usable by disparate companies, departments, and/or offices. These functions include, but are not limited to, accounting, lending, collection, and file storage.

User devices 300 through 330 are capable of communicating with auction server 200 over communication network 100, and of presenting an interface to a user in operation thereof. A user according to some embodiments of the present invention is a representative of a car dealership, although in some embodiments users include private individuals. User devices 300, 320 and 330 comprise a personal computer, a personal digital assistant, and a personal computer, respectively, while user device 310 comprises a network server that serves data and applications to network terminals such as user devices 312 through 318. Of course, user devices 300 through 330 may provide respective operators with functionality unrelated to the present invention.

In some embodiments, the devices of FIG. 1 are connected differently than as shown. For example, some or all of the devices may be connected directly to one another. Of course, embodiments of the invention may include devices that are different from those shown. It should also be noted that although the devices are shown in communication with each other, the devices need not be constantly exchanging data. Rather, communication may be established when necessary and severed at other times or always available but rarely used to transmit data. Moreover, although the illustrated communication links appear dedicated, it should be noted that each of the links may be shared by other devices.

Auction Server

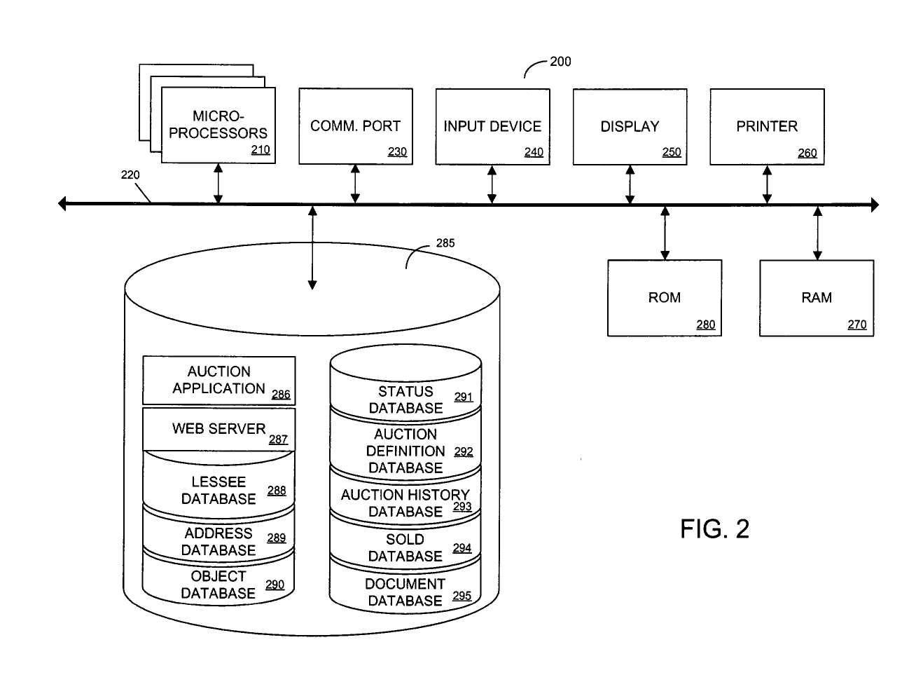

FIG. 2 is a block diagram of an internal architecture of auction server 200 according to some embodiments of the invention. As illustrated, auction server 200 includes microprocessors 210 in communication with communication bus 220. Microprocessors 210 may comprise RISC-based and other types of processors and are used to execute processor-executable process steps so as to control the elements of auction server 200 to provide desired functionality.

Also in communication with communication bus 220 is communication port 230. Communication port 230 is used to transmit data to and to receive data from devices external to auction server 200 such as devices 300 through 330. Communication port 230 is therefore preferably configured with hardware suitable to physically interface with desired external devices and/or network connections. For example, communication port 230 may comprise an Ethernet connection to a local area network through which auction server 200 may receive and transmit information over the Web.

Input device 240, display 250 and printer 260 are also in communication with communication bus 220. Any known input device may comprise input device 240, including a keyboard, mouse, touch pad, voice-recognition system, and any combination of these devices. Of course, information may also be input to auction server 200 from other devices via communication port 230. Information input to auction server 200 includes information defining an item and auction parameters for auctioning the item.

Display 250 may be an integral or separate CRT display, flat-panel display or the like used to display graphics and text in response to commands issued by microprocessors 210. Such graphics and text may comprise an interface for controlling auctions in accordance with some embodiments of the present invention. Printer 260 may also present text and graphics to an operator, but in hardcopy form using ink-jet, thermal, dot-matrix, laser, or other printing technologies.

RAM 265 is connected to communication bus 220 to provide microprocessors 210 with fast data storage and retrieval. In this regard, processor-executable process steps being executed by microprocessors 210 are typically stored temporarily in RAM 270 and executed therefrom by microprocessors 210. ROM 280, in contrast, provides storage from which data can be retrieved but to which data cannot be stored. Accordingly, ROM 280 is used to store invariant process steps and other data, such as basic input/output instructions and data used during boot-up of auction server 200 or to control communication port 230. It should be noted that one or both of RAM 270 and ROM 280 may communicate directly with microprocessors 210 instead of over communication bus 220.

Data storage device 285 stores, among other data, processor-executable process steps of auction application 286. Microprocessors 210 therefore execute the process steps of auction application 286 in order to control auction server 200 to facilitate auction management according to some embodiments of the present invention.

The process steps of auction application 286 may be read from a computer-readable medium, such as a floppy disk, a CD-ROM, a DVD-ROM, a Zip™ disk, a magnetic tape, or a signal encoding the process steps, and then stored in data storage device 285 in a compressed, uncompiled and/or encrypted format. In alternative embodiments, hard-wired circuitry may be used in place of, or in combination with, processor-executable process steps for implementation of processes according to embodiments of the present invention. Thus, embodiments of the present invention are not limited to any specific combination of hardware and software.

Process steps of Web server 287 are also stored in data storage device 285. Microsoft Internet Information Server™ is one suitable example of Web server 287. The process steps of Web server 287 may be executed by microprocessors 210 to transmit data to and to receive data from Web clients, such as Web browsers, over the Web. The data may include authorization information, auction bids and other information received from user devices 300 through 330.

Some process steps of Web server 287 may provide Web-based communication via a secure protocol such as secure hypertext transfer protocol (HTTPS). HTTPS is a communications protocol designed to transfer encrypted information between computers over the World Wide Web. Generally the HTTPS protocol is equivalent to a combination of the more-common HTTP protocol and the Secure Socket Layer (SSL) encryption protocol.

Lessee database 288 of data storage device 285 includes information associated with lessees who have entered into car leases and/or loans with the entity operating auction server 200 and/or with one or more other institutions. Address database 289 includes addresses that are associated with the auctioning of a particular item, such as addresses of the lending institution, the lessee, the buyer, the possessor of the item, and the like. Object database 290 of data storage device 285 includes details of items, or objects, which will be, are being, or have been auctioned. In the present example, these objects are cars.

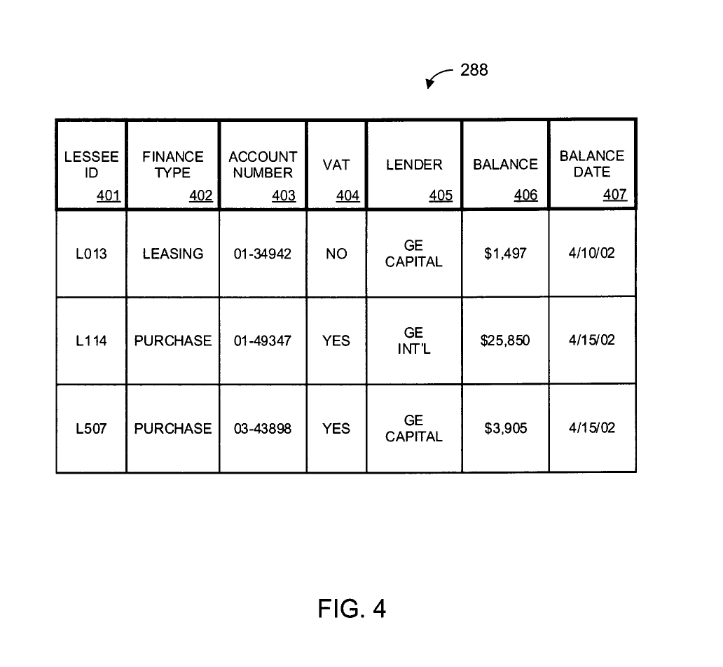

Data storage device 285 also stores status database 291, auction definition database 292, auction history database 293, sold database 294 and document database 295. Status database 291 provides details relating to repossession of a car, while auction definition database 292 includes some parameters based on which an auction may be conducted. Auction history database 293 stores data produced during auctions conducted by auction server 200, such as submitted bids and the like. Sold database 294 provides details on the sale of an auctioned object, while document database includes information used to generate documents according to some embodiments of the present invention. The information stored in databases 288 through 295 is described in more detail below with respect to FIGS. 4 through 11.

Also stored in data storage device 285 may be other unshown elements that may be necessary for operation of auction server 200. These elements may include an operating system such as Microsoft Windows 2000™, a database management system such as MS-SQL 7.0 with ODBC driver, a backup application, other applications, other data files, and “device drivers” for allowing microprocessors 210 to interface with devices in communication with communication port 230. These elements are known to those skilled in the art, and are therefore not described in detail herein.

User Device

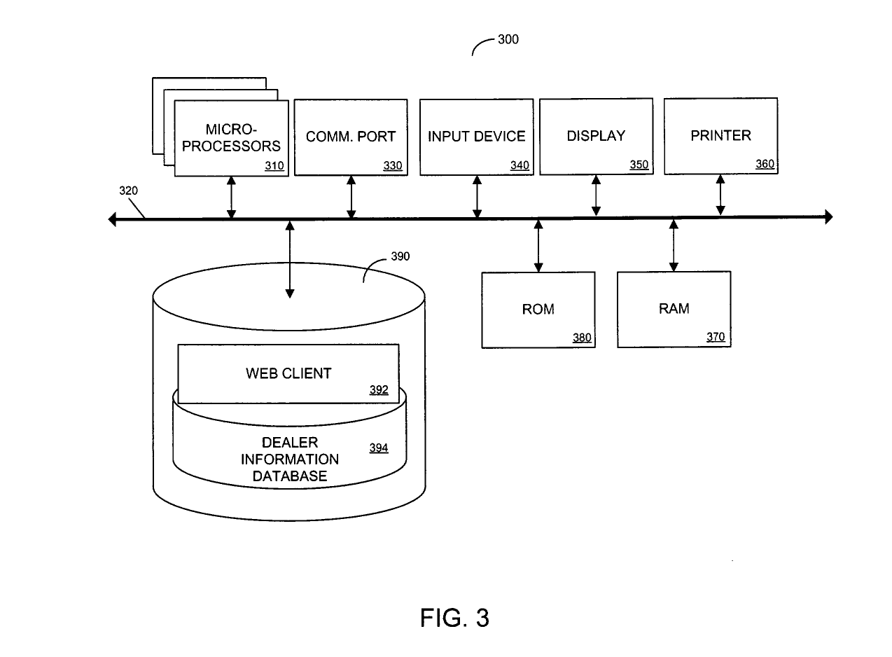

FIG. 3 is a block diagram of the internal components of user device 300 according to some embodiments of the invention. It should be noted that these distinct components may comprise any of the specific examples given above with respect to identically-named components of auction server 200. Of course, specific functions performed by the components may differ from the functions performed by the identically-named components.

In operation, process steps of Web client 392 are executed by microprocessor 310 to receive interfaces associated with an auction from auction server 200 and to transmit bids to auction server 200. The interfaces may be presented to a dealer by display 350 and the bids may be input by the dealer using input device 340. Input device 340 and display 350 may also be used in conjunction with applications that are not directly related to the present invention.

Data storage device 390 also stores dealer information database 394. Database 394 includes information that may be transmitted to auction server 200 and used thereby to determine whether a user of user device 300 is authorized to submit bids. As alluded to above, storage device 390 may store one or more of other applications, data files, device drivers and operating system files needed to provide functions other than those directly related to the present invention. Such functions may include calendaring, e-mail access, word processing, accounting, presentation development and the like.

Databases

A tabular representation of a portion of lessee database 288 is shown in FIG. 4. As described above, the information stored in lessee database 288 may be associated with lessees who have entered into car leases and/or loans with the entity operating auction server 200. Lessee database 288 of FIG. 4 includes several records, each consisting of several fields. The fields include lessee Id field 401, finance type field 402, account number field 403, Value Added Tax (VAT) field 404, lender field 405, balance field 406, and balance date field 407.

Lessee Id field 401 includes an identifier that may be used throughout the databases described herein to identify a particular lessee. In the case of database 288 of FIG. 4, the identifier of a record identifies a lessee who is associated with the data populating other fields of the record. The identifier may be assigned by auction server 200 or may be received from another device.

Finance type field 402 specifies a type of agreement on which an associated lessee has defaulted, and account number field 403 specifies an account number associated with the agreement. For example, the data of account number field 403 that is associated with a “purchase” finance type may comprise a loan number.

VAT field 404 identifies whether a VAT is associated with the subject record. Lender field 405 indicates an entity that provided the subject lease or loan to the lessee specified in associated lessee ID field 401. Balance field 406 indicates a remaining balance on the loan or lease, and balance date field 407 specifies a date on which the balance was equal to that specified in balance field 406.

The information stored in lessee database 288, as well as that stored in each other of the databases of auction server 200, may be received from a variety of sources, including lending institutions, public records, an operator of input device 240, user devices 300 through 330, and other devices.

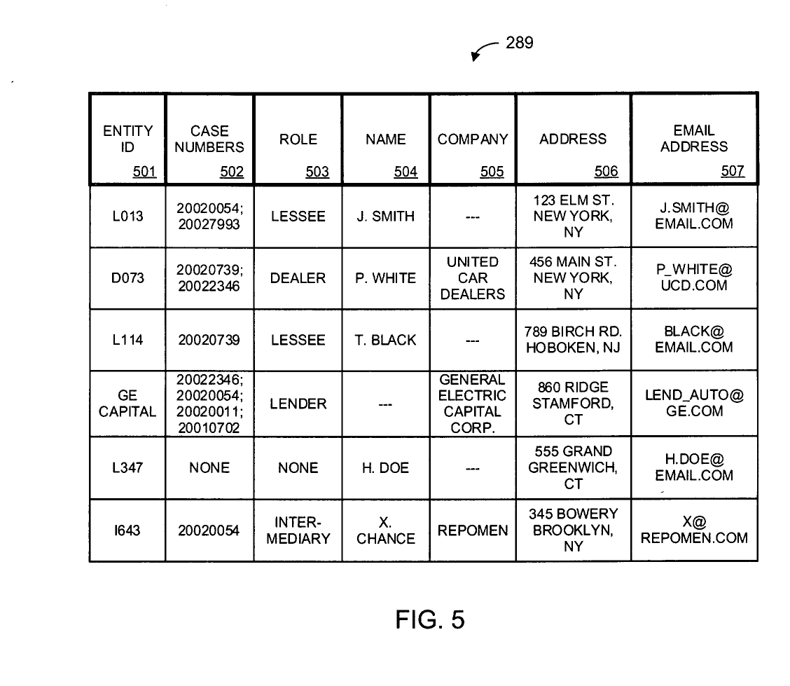

FIG. 5 illustrates a tabular representation of a portion of addresses database 289. Addresses database 289 includes addresses that are associated with the auctioning of a particular item. Specifically, the fields of each record of database 289 include entity Id field 501, case numbers field 502, role field 503, name field 504, company field 505, address field 506, and email address field 507.

Entity Id field 501 of a record identifies an entity that is the subject of the record. Identified entities may include a lessee, a dealer, a lending institution, and an intermediary repossessor. Case numbers field 502 lists case numbers associated with a subject entity, wherein each case number identifies an auction for a particular car, or object. Role field 503 specifies a role of the subject entity in the auction, and name field 504 includes a name of an individual represented by an entity Id associated with the record. Company field 505, address field 506 and email address field 507 respectively specify a company, if any, an address, and an email address associated with the entity Id. The information stored in address database 289 may be used to generate documents and/or electronic mail according to some embodiments of the present invention.

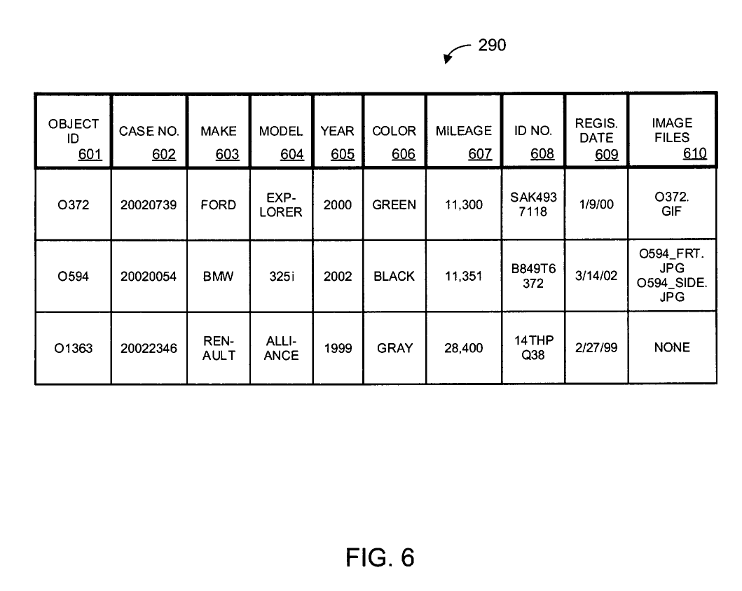

A tabular representation of a portion of object database 290 is shown in FIG. 6. Object database 290 provides details of cars, or objects that will be, are being, or have been auctioned. The records of database 290 include object id field 601, which identifies a particular car that has been repossessed or otherwise obtained for auction. Case number field 602 provides a case number associated with the particular car and therefore associated with an auction for selling the car. Make field 603, model field 604, year field 605, color field 606, mileage field 607, Id number field 608 and registration date field 609 respectively specify identically-named attributes of an associated car. Image files field 610 identifies image files depicting an associated car. The image files may be stored in a predefined folder of data storage device 290. The details included in object database 290 may be transmitted to bidders prior to and during an auction to inform the bidders regarding auctioned objects.

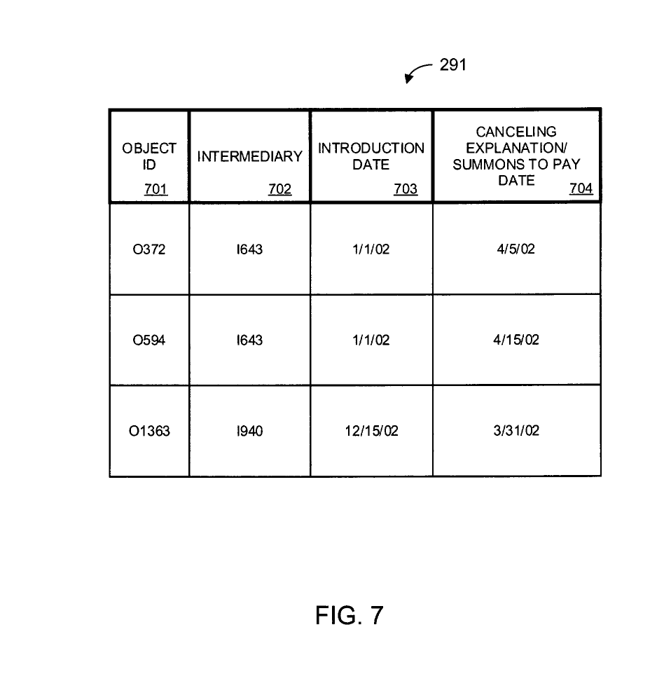

The tabular portion of status database 291 illustrated in FIG. 7 stores information associated with the repossession of a car. In particular, each record of status database 291 identifies a particular car in object Id field 701, and includes an identifier of an intermediary who repossessed the car record in intermediary field 702. Introduction date field 703 includes a date on which an individual in possession of the car was notified of impending repossession, and canceling explanation/summons to pay date field 704 specifies a date on which the car was repossessed.

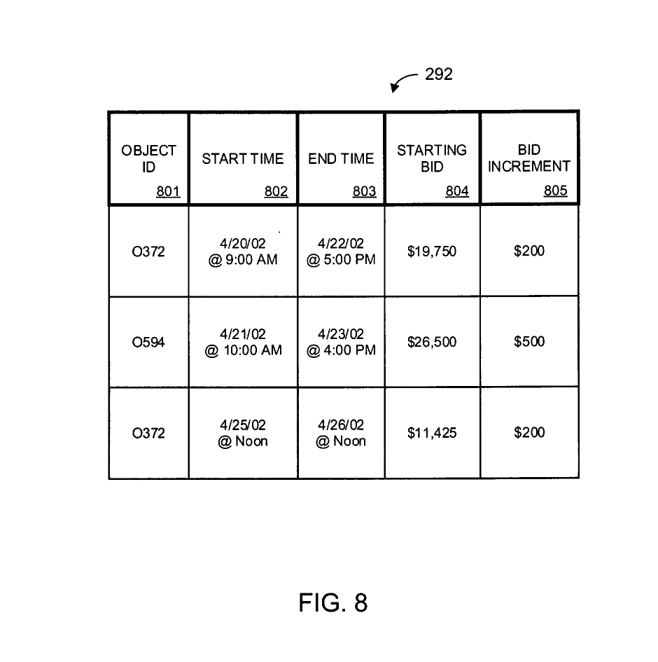

FIG. 8 illustrates a tabular representation of a portion of auction definition database 292. As shown, auction definition database 292 provides parameters for conducting an auction of an object. Object ID field 801 of a record identifies an object, while fields 802 through 805 identify parameters for conducting an auction of the object. Specifically, start time field 802 and end time field 803 specify a start time and an end time of an auction, while starting bid field 804 and bid increment field 805 specify a starting bid and bid increment for use in the auction. The values populating fields 802 through 805 may be input by an operator of auction server 200 into an interface provided by auction application 286.

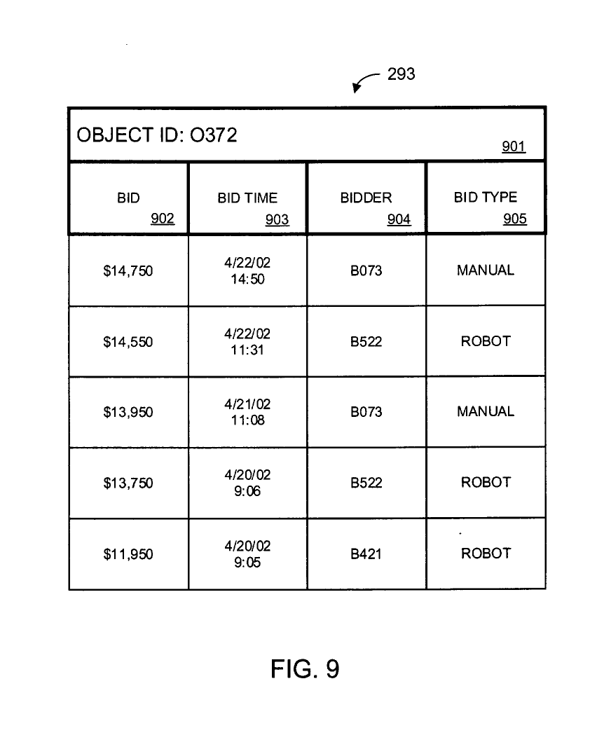

FIG. 9 illustrates a tabular representation of a portion of auction history database 293. The auction history information stored in the portion is associated with a particular object identified in object ID field 901. Of course, it is contemplated that auction history database 293 may include auction history information associated with more than one object.

The auction history information of auction history database 293 comprises information relating to bids submitted to auctions. In the present example, the information shown in FIG. 9 relates to bids submitted in an auction for an object associated with object Id “O372”. Specified for each bid are a bid amount in bid field 902, a time at which the bid was submitted in bid time field 903, an identity of the bidder in bidder field 904, and a mechanism by which the bid was submitted in bid type field 905.

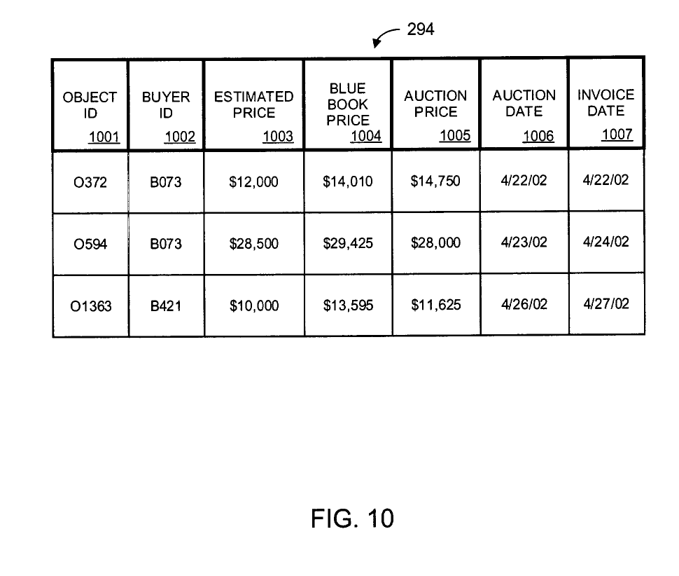

A representation of a tabular portion of sold database 294 is illustrated in FIG. 10. Each record of sold database 294 provides information relating to a sale of an object resulting from an auction of the object. The object is identified in object Id field 1001, and the winning bidder is identified in buyer Id field 1002. A current blue book price of the object is presented in blue book price field 1004 along with an auction price for which the object is sold in auction price 1005. Sold database 294 also specifies, in auction date field 1006 and invoice date field 1007, a date on which the auction ended and a date on which an invoice for the auction price was transmitted to the buyer.

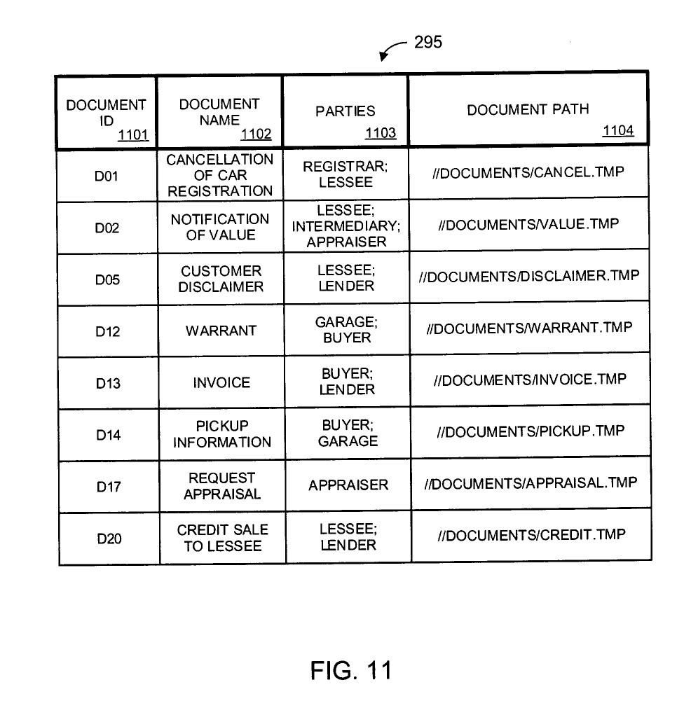

FIG. 11 illustrates a tabular representation of a portion of document database 295. Document database 295 stores information related to documents that can be manually and/or automatically generated and/or transmitted by a system according to some embodiments of the present invention. Specifically, the fields of each record of database 295 include document Id field 1101, document name field 1102, parties field 1103, and document path field 1104. Document Id field 1101 identifies a document, and document name field 1102 provides a descriptive name of the document. Parties field 1103 identifies entities who are parties to the document. The document therefore includes fields that should be filled with information, such as address information, relating to the identified parties. Document path field 1104 specifies a network path of an associated document template. The document templates may be stored in data storage device 285 of auction server 200 or elsewhere.

It should be noted that the illustrations and accompanying descriptions of databases included herein merely represent relationships between stored information. A number of other arrangements may be employed besides those suggested, including arrangements in which some or all of the specified data is located remote from auction server 200. It is further contemplated that each of the databases may include many more records than those shown and that each record may include associated fields other than those illustrated.

Auction Process

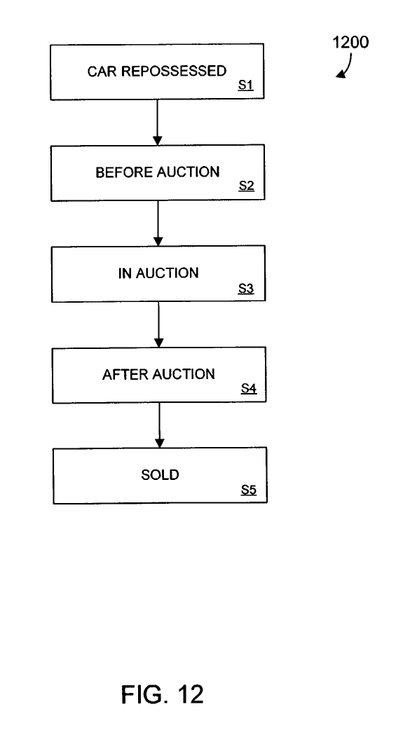

FIG. 12 comprises state diagram 1200 according to some embodiments of the present invention. A system governed by state diagram 1200 is described below as if embodied in auction application 286 and executed by microprocessors 210 of auction server 200. However, state diagram 1200 may be embodied in one or more software or hardware elements and executed, in whole or in part, by any device or by any number of devices in combination, including auction server 200 and user devices 300 through 330.

In some embodiments, state S1 is entered upon receiving an indication that a car has been repossessed. Auction server 200 may receive such an indication from a device operated by an intermediary or by an operator of auction device 200 through input device 240. According to a specific example of the latter scenario, an operator of auction device may use input device 240 to input a command to launch a Web browser.

After the Web browser is launched, a Web browser window is presented on display 250. The operator enters a Uniform Resource Locator (URL) into the window corresponding to Web server 287. Accordingly, a request is transmitted to Web server 287 and, in conjunction with auction application 286, a Web page is transmitted to the Web browser. Such an arrangement allows the Web page to be accessed by devices remote from auction server 200.

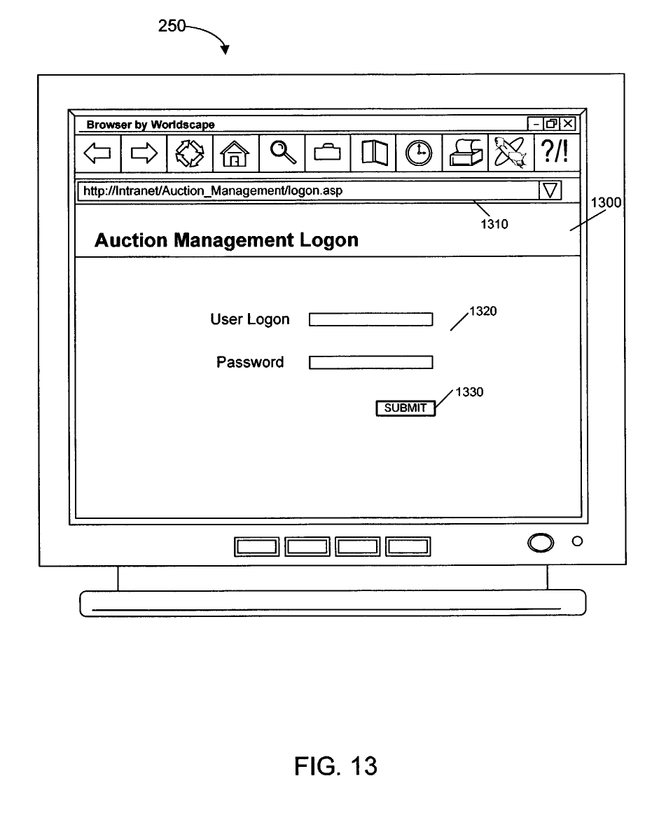

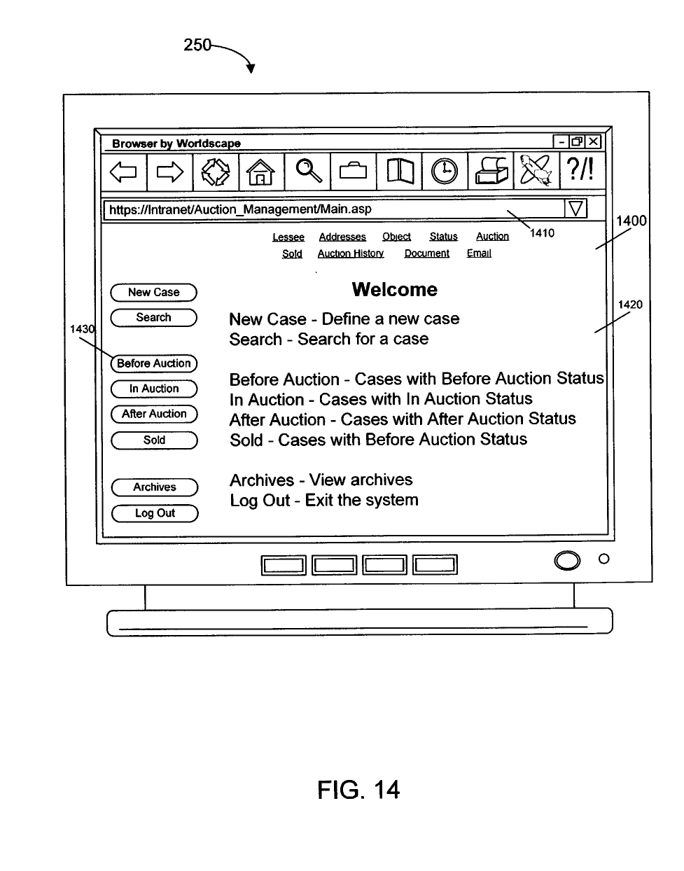

FIG. 13 illustrates display 250 after receipt of the Web page. As shown in FIG. 13, interface 1300 includes input are 1320 for inputting a user logon and password. Upon selection of Submit button 1320, the user logon and password are transmitted to Web server 287. The user logon and password are evaluated by auction application 286 and, if it is determined that the logon and password are valid, interface 1400 of FIG. 14 is presented on display 250. It should be noted that some embodiments of the invention provide multiple levels of access to auction management. Accordingly, interfaces 1400 through 2400 of these embodiments may differ depending upon an access level of a logged-on operator.

URL input area 1410 of FIG. 14 indicates that interface 1400 was received using the secure HTTPS protocol. Also shown in interface 1400 are welcome instructions 1420 and control buttons 1430. As described in welcome instructions 1420, control buttons 1430 may be used to view cases having a current status of “Before Auction”, “In Auction”, “After Auction”, and “Sold”. Moreover, certain ones of control buttons 1430 may be used to view data archives or to log out of the system.

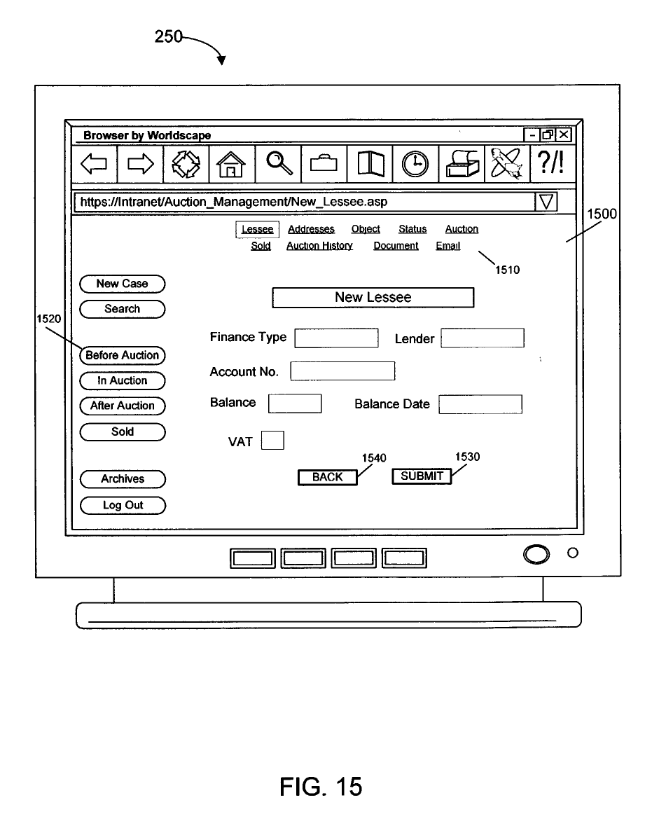

If a case is currently in state S1, the operator may select the New Case control button of interface 1400. In response to this selection, interface 1500 of FIG. 15 is received from Web server 287 and presented by display 250. Interface 1500 includes navigation links 1510, one of which is highlighted to indicate its association with the presented interface. Input area 1520 may be used to input the information relating to a lessee of the type described above with respect to lessee database 288. Submit button 1530 may be selected to submit information input into area 1520 to Web server 287 and auction application 286. As a result, the submitted information is stored in a newly-created record of lessee database 288.

Back button 1540 may be selected to return to a previously-displayed page without submission of data input into input area 1520. In this regard, Back buttons shown in subsequently-described interfaces provide those interfaces with similar functionality. Also, the selection of Submit buttons provided by these interfaces causes input data to be stored in an appropriate database of data storage device 285.

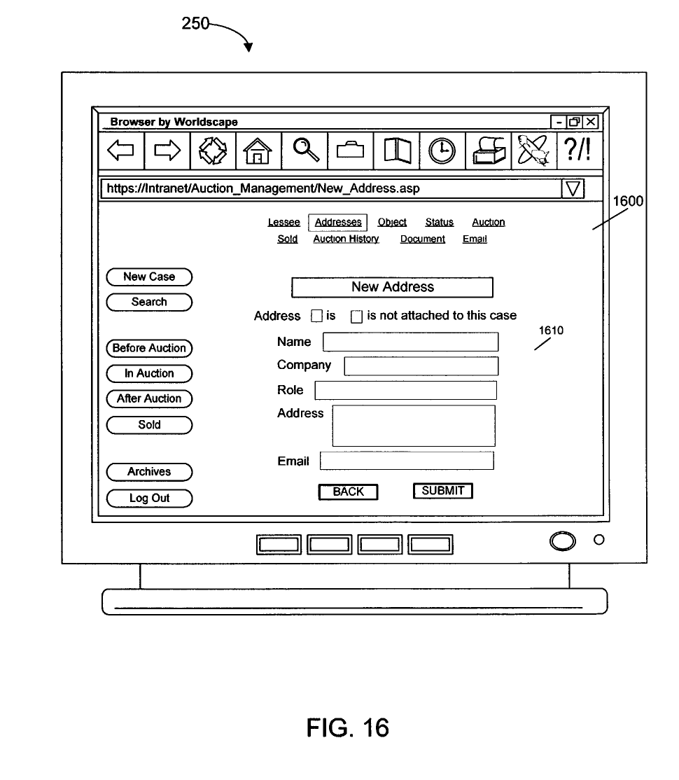

FIG. 16 shows interface 1600 as displayed in response to selection of Submit button 1530 of FIG. 15. Input area 1610 of interface 1600 may be used to specify address information to associate with the newly-created case in address database 289. According to the illustrated embodiment, also associated with the case in address database 289 is a case number used to populate an associated case numbers field 502. As shown in FIG. 5, an address input using interface 1600 may be associated with more than one case.

Still with respect to state S1, edit object interface 1700 provides input area 1710 for inputting information stored by object database 290. The input information corresponds to a repossessed car for which a new case is being created. Accordingly, the input information is stored in association with a case number corresponding to the new case in case number field 602 of object database 290. Status interface 1800 of FIG. 1800 is then presented in response to selection of the Submit button of interface 1700 and/or selection of navigation link 1810. Status interface 1800 provides input area 1820 for inputting information relating to repossession of the subject car. As described above, this information is stored in status database 291 in response to selection of Submit button 1830.

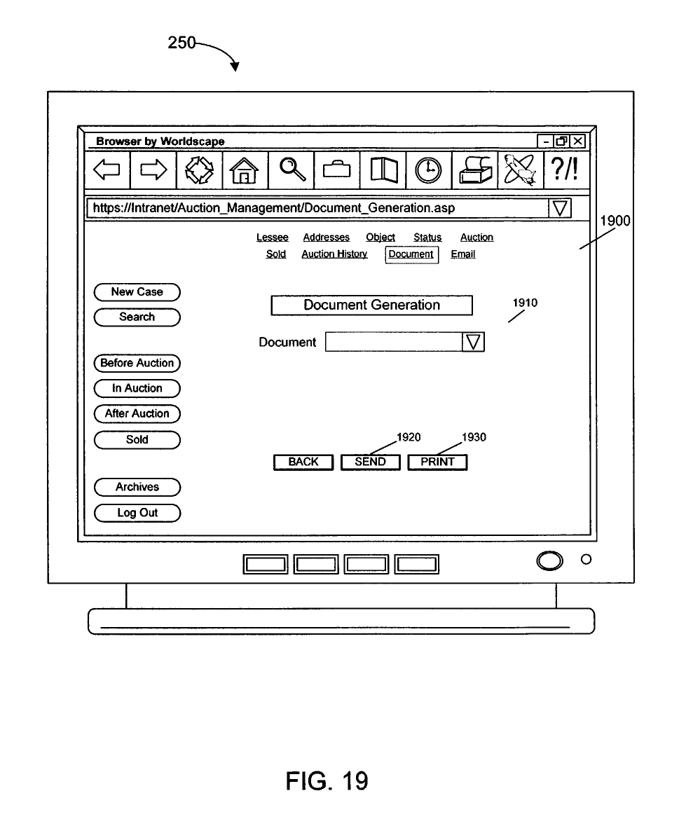

Interface 1900 of FIG. 19 is presented to the operator to allow the operator to generate required documents. Pull-down menu 1910 includes a list of document names from document field 1102 of document database 295. A document name is selected from the list and Send button 1920 is selected to cause auction server 200 to generate the selected document based on a template associated with the document name in database 295 and on address information of parties associated with the template, and to send the document to an intended recipient. Print button 1950 may be used to generate the document and to print the document using printer 260. In state S1, an Appraisal Request that requests an appraised value of the car is generated and transmitted to an appraiser using interface 1900.

Interface 2000 may also be used to generate and transmit a communication to a particular entity. Interface 200 may be presented in response to selection of Email navigation link 2010, and allows an operator to compose an electronic mail message using input fields 2020. An electronic mail message may also be generated using the document templates of document template database by selecting a document name in pull-down menu 2030. Send button 2040 allows the operator to transmit the composed message to an intended recipient. In some embodiments of state S1, a document or electronic mail message requesting an appraisal is automatically generated and transmitted to an appraiser upon receiving any indication that the subject car has been repossessed. This indication may comprise submission of object details using the Submit button of interface 1700.

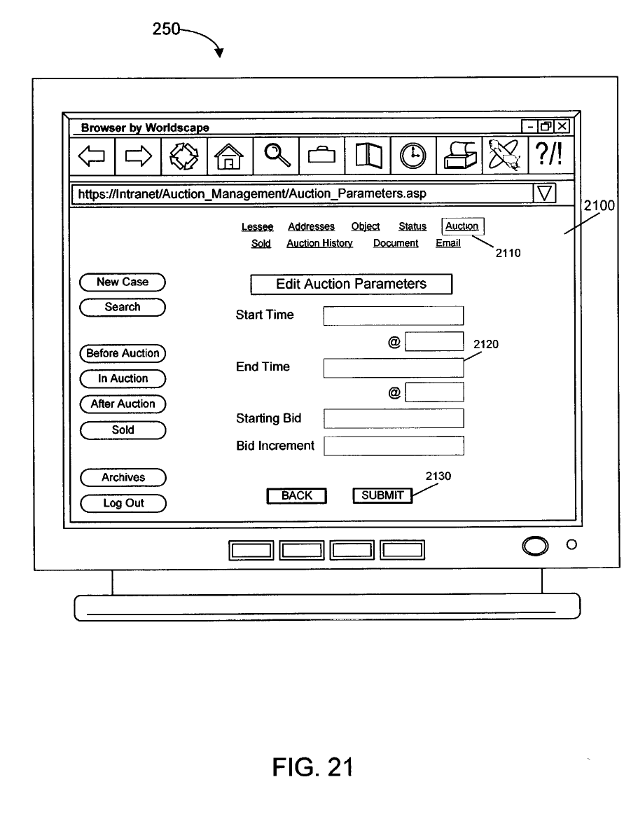

Once the appraisal is received, a system according to some embodiments of the invention enters state S2. Reception of the appraisal may be detected electronically by receiving an electronic signal embodying the appraisal from the appraiser. The appraisal may also be detected by detecting entry of auction parameters into interface 2100 of FIG. 21. More specifically, the operator of auction server 200 may receive an appraisal and select Auction navigation link 2110 so as to be presented with interface 2100. Auction parameters such as those described with respect to auction definition database 292 are input into input area 2120 and stored in database 292 using Submit button 2130. As described above, the auction parameters are used to conduct an auction for the subject car. It should be noted that a starting bid input into input area 2120 may be equal to or different from the received appraised value.

In response to reception of the appraised value, the value may be automatically transmitted to a lessee associated with the new case. Moreover, a request to cancel a registration of the item may be automatically transmitted in response to reception of the appraised value. In addition, an agreement may be generated that indicates that the individual from whom the item was repossessed disclaims any right they may have to sell the item. The value, the request and/or the agreement may be transmitted by generating associated documents and/or electronic mail messages using information from document database 295 and from other databases of data storage device 285.

The system remains in state S2 until an auction start time defined using interface 2100. Once the auction start time arrives, the system enters state S3 and auction application 286 and Web server 287 operate to conduct an auction based on the defined auction parameters. The auction may be conducted in any currently or hereafter-known manner. In one specific example, a dealer uses input device 340 of user device 300 to execute Web browser 392. The dealer accesses a bidding website provided by Web server 287 and auction application 286 and logs on to the website using assigned logon information. Auction server 200 confirms the dealer's permission to access the website and transmits Web pages to user device 300 that allow the dealer to view objects currently being auctioned and to submit bids for the objects. Of course, several dealers using disparate user devices may submit bids to a single auction.

It should be noted that the bidding dealers are not able to access interfaces 1300 through 2400. Rather, these interfaces are accessible by entities, such as the operator of the present example, who are authorized to manage the auction. In this regard, the operator may access interface 2200 during a period between a defined auction start time and a defined auction end time to view submitted bids.

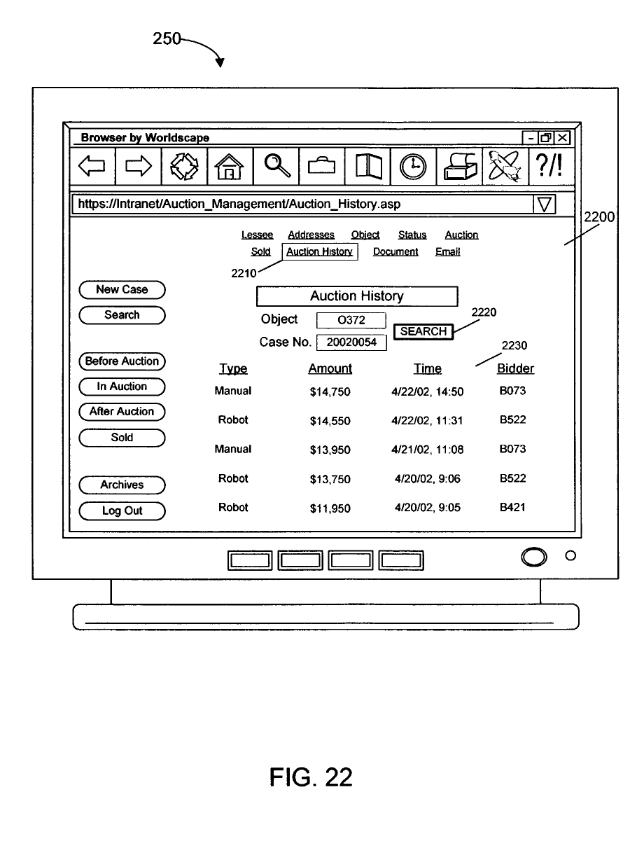

As shown in FIG. 22, interface 2200 is presented in response to selection of Auction History navigation link 2210. Search area 2220 allows an operator to search auction bid information stored in auction history database 293 using an object Id and/or a case number. Bid information area 2230 presents bid information associated with an auction identified by the search. Interface 2200 may also be accessed after an auction is completed in order to view bids that were submitted to the auction.

State S4 is entered after completion of an auction. According to some embodiments of state S4, instructions for obtaining the auctioned item are automatically transmitted to the auction winner, an invoice for the item is automatically transmitted to the auction winner, a notification is automatically transmitted to a possessor of the item identifying the auction winner and indicating that the auction winner has permission to obtain the item, and a notification is transmitted to the lessee indicating an amount to be credited to an account of the lessee. Automatic transmission of the instructions, invoice and notifications may be triggered by any indication that the auction is completed, including an indication that a current time is later than an auction end time specified in auction definition database 290. The instructions, invoice and notifications may be generated based on document information stored in document database 295 and may also be generated using interfaces 1900 and/or 2000.

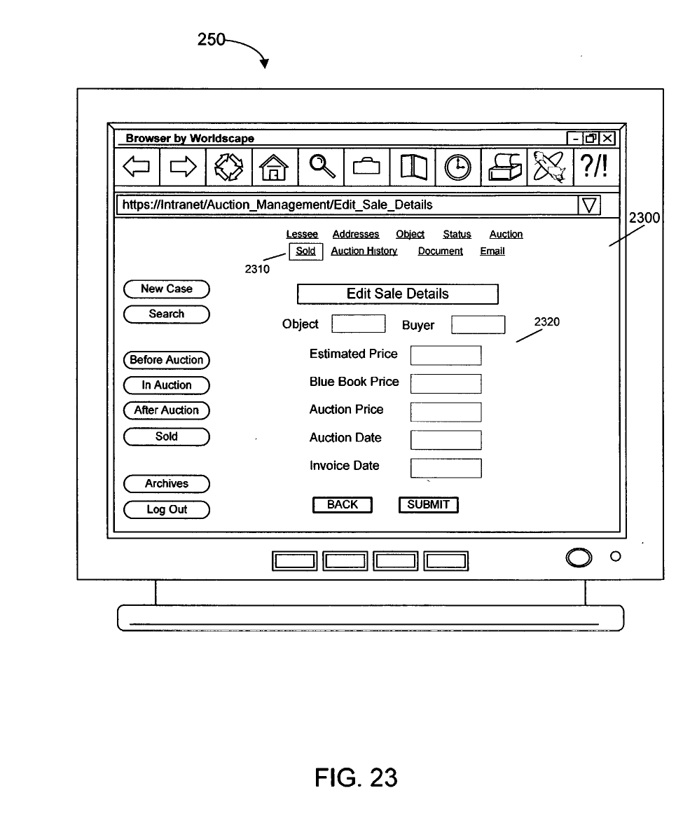

After transmission of the foregoing, interface 2300 of FIG. 23 is used in state S5 to input sale details to auction server 200. More specifically, Sold navigation link 2310 is selected and interface 2300 is presented in response. Sale details are then input into input area 2320, and the details are stored in sold database 294 of data storage device 290.

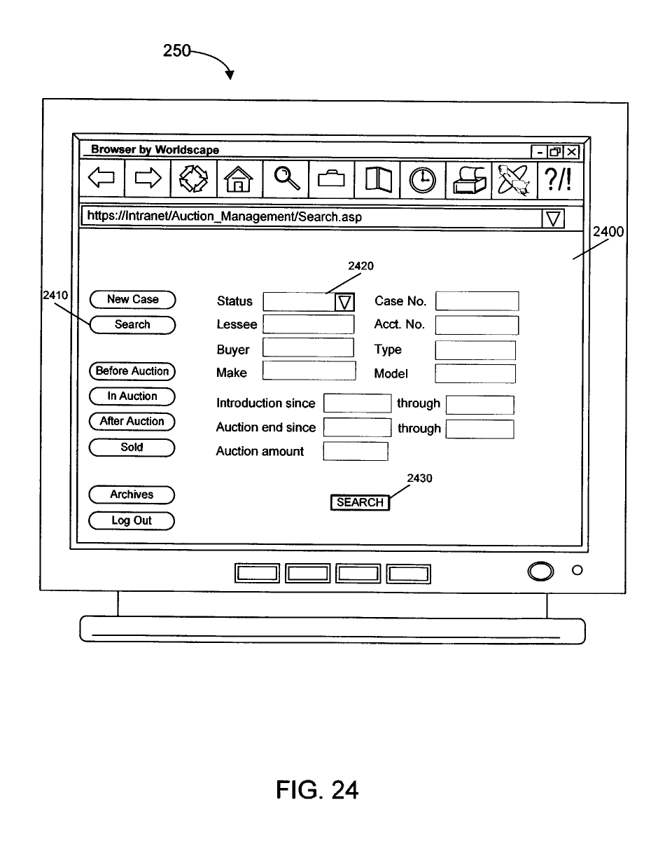

FIG. 24 is an outward view of display 250, which presents interface 2400 in response to selection of “Search” control button 2410. As shown, interface 2400 provides search fields 2420 which may be used to search for a particular case for which information is stored in data storage device 285. Particularly, the operator completes one or more of the search fields with search terms describing a desired case, and selects Search button 2430 to submit the search terms to Web server 287 and auction application 286. Details of cases corresponding to the search terms then presented to the operator. As described above, case details may also be accessed using other control buttons shown on the left side of interface 2400.

Systems according to some embodiments of the present invention thereby provide efficient execution of procedures and/or generation of documents that are associated with the sale of some types of items. It should be noted that the process steps may be altered to create embodiments of the invention completely or partially different from any of the arrangements mentioned herein without departing from the spirit and scope of the present invention.

What is claimed is:

1. A system for auctioning an item, comprising:
receiving an indication that the item has been repossessed;
transmitting a request for an appraisal of a value of the item;
receiving an appraised value of the item;
in response to reception of the appraised value, automatically transmitting the appraised value to a lessee of the item;
in response to reception of the appraised value, automatically generating a request to cancel a registration of the item;
determining parameters of an auction for the item;
conducting the auction of the item based on the determined parameters;
in response to completion of the auction, automatically transmitting a notification to a possessor of the item identifying an auction winner and indicating that the auction winner has permission to obtain the item;
in response to completion of the auction, automatically transmitting instructions for obtaining the item to the auction winner;
in response to completion of the auction, automatically transmitting an invoice for the item to the auction winner; and
in response to completion of the auction, automatically transmitting a notification to the lessee indicating an amount to be credited to an account of the lessee.

2. A method for auctioning registered items, comprising:
receiving an appraised value of an item;
in response to reception of the appraised value, automatically generating a request to cancel registration of the item; and
conducting an auction of the item.

3. A method according to claim 2, further comprising:
in response to reception of the appraised value, automatically generating a notification of the appraised value and transmitting the notification to an individual from whom the item was repossessed.

4. A method according to claim 2, further comprising:
in response to reception of the appraised value, generating an agreement indicating that an individual from whom the item was repossessed disclaims a right to sell the item.

5. A method according to claim 2, further comprising:
prior to conducting the auction, receiving a brand, a make, a model year, a color, a bidding increment, and a start price associated with the item.

6. A method according to claim 2, further comprising:
in response to completion of the auction, automatically transmitting a notification to a possessor of the item identifying an auction winner and indicating that the auction winner has permission to obtain the item.

7. A method according to claim 6, further comprising:
in response to completion of the auction, automatically transmitting instructions for obtaining the item to the auction winner.

8. A method according to claim 7, further comprising:
in response to completion of the auction, automatically transmitting an invoice for the item to the auction winner.

9. A method according to claim 2, further comprising:
in response to completion of the auction, automatically transmitting a notification to the lessee indicating an amount to be credited to an account of the lessee.

10. An interface for controlling an auction, comprising:
an input area for inputting an appraised value of an item,
wherein in response to input of the appraised value into the input area, a request to cancel registration of the item is automatically generated.

11. An interface according to claim 10, further comprising:
in response to input of the appraised value into the input area, a notification of the appraised value is automatically generated and transmitted to an individual from whom the item was repossessed.

12. An interface according to claim 10, further comprising:
in response to input of the appraised value into the input area, an agreement indicating that an individual from whom the item was repossessed disclaims a right to sell the item.

13. An interface according to claim 10, further comprising:
input areas for receiving a brand, a make, a model year, a color, a bidding increment, and a start price associated with the item.

14. An interface according to claim 13, wherein the brand, make, model year, color, bidding increment, and start price associated with the item must be received before an auction associated with the item can be conducted.

15. An interface according to claim 10, wherein, in response to completion of an auction associated with the item, a notification is automatically transmitted to a possessor of the item, the notification identifying an auction winner and indicating that the auction winner has permission to obtain the item.

16. An interface according to claim 15, wherein, in response to completion of the auction, instructions for obtaining the item are automatically transmitted to the auction winner.

17. An interface according to claim 16, wherein, in response to completion of the auction, an invoice for the item is automatically transmitted to the auction winner.

18. An interface according to claim 10, wherein, in response to completion of the auction, a notification is automatically transmitted to an individual from whom the item was repossessed, the notification indicating an amount to be credited to an account of the individual.

19. A device for controlling an auction, comprising:
a processor; and
a storage device in communication with the processor and storing instructions adapted to be executed by the processor to:
receive an appraised value of an item;
in response to reception of the appraised value, automatically generate a request to cancel registration of the item; and
conduct an auction of the item.

20. A device according to claim 19, the instructions further adapted to be executed by the processor to:
automatically generate, in response to reception of the appraised value, a notification of the appraised value and transmit the notification to an individual from whom the item was repossessed.

22. A device according to claim 21, the instructions further adapted to be executed by the processor to:
automatically transmit, in response to completion of the auction, a notification to an individual from whom the item was repossessed indicating an amount to be credited to an account of the individual.
